(19) United States
(12) Patent Application Publication
(10) Pub. No.: US 2021/0176960 A1
(43) Pub. Date: Jun. 17, 2021

(54) Pet Cleaning Enclosure

(71) Applicant: Stephen D Pigue, Nolensville, TN (US)

(72) Inventor: Stephen D Pigue, Nolensville, TN (US)

(21) Appl. No.: 17/121,227

(22) Filed: Dec. 14, 2020

Related U.S. Application Data
(60) Provisional application No. 62/947,810, filed on Dec. 13, 2019.

(51) Int. Cl. A01K 13/00; A01K 1/02

(52) U.S. Cl. CPC A01K 13/001; A01K 1/0245

(57) ABSTRACT

Aspects of the invention provide a pet cleaning system. In an embodiment, the pet cleaning system includes a pet cleaning system, comprising: an enclosure for containing a pet, the enclosure including: a cover; and a base, wherein the cover connects to the base to form a cavity surrounded by a plurality of sides; and a plurality of connected pipes attached to the cover of the enclosure, wherein at least one of the plurality of connected pipes includes an attachment means to connect to an existing water supply, and wherein the plurality of connected pipes are configured to spray water into the cavity of the enclosure.

### REFERENCE TO RELATED APPLICATIONS

The current application claims the benefit of U.S. Provisional Application No. 62/947,810, titled “Pet Cleaning Enclosure,” which was filed on 13 Dec. 2019, and which is hereby incorporated by reference.

### TECHNICAL FIELD

The disclosure relates generally to an enclosure used for cleaning pets.

### BACKGROUND ART

Pets, such as dogs, can often get dirty, muddy, and smelly due to the environment, their habits (such as digging, running in the mud, swimming, hunting, and/or the like), or getting into trouble (e.g., going through the trash). For any pet owner, it can be a cumbersome and messy job to clean a pet. However, it is a necessary job. It can be expensive and time consuming to bring a pet to a groomer, especially if a pet needs to be cleaned often. However, the options for cleaning a pet at home are not easy. Usually, the process includes making another mess, while drenching the pet owner and the surrounding area, as it is common for a pet to resist getting cleaned.

Currently, when cleaning a pet without a groomer, the options are limited to a bathtub or outside. When cleaning a pet in a bathtub, there is nothing that prevents a pet from jumping out of the tub, which can make an even bigger mess. There is also nothing that prevents the owner from getting splashed by the water while cleaning the pet. While cleaning a pet outside, an owner can be limited by access to water, temperature, and/or location. If access to water outside of the home is not available, the owner would need a basin or tub that would need to be filled with water from inside the home. This could be burdensome. Cleaning a pet outside would also be undesirable in colder temperatures. Even if there is access to water outside, and the temperature is adequate, if the outdoor yard is very muddy, it could feel pointless to clean a pet in the yard.

### SUMMARY OF THE INVENTION

Aspects of the invention provide a pet cleaning system. In an embodiment, the pet cleaning system includes an enclosure for containing the pet. The enclosure has a plurality of sides forming a hollow interior. At least one of the plurality of sides can comprise a solid piece of material. An opening, e.g., accessible by a door, can be located on one side of the enclosure to access the hollow interior. A plurality of connected pipes can be attached to the enclosure and at least one of the plurality of connected pipes can include an attachment means to connect to an existing water hose so that the plurality of connected pipes can spray water into the hollow interior of the enclosure. The enclosure also can include a drain for draining water from the enclosure.

A first aspect of the invention provides a pet cleaning system, comprising: an enclosure for containing the pet, the enclosure including: a plurality of sides forming a hollow interior; and an opening to access the hollow interior of the enclosure; a plurality of connected pipes attached to the enclosure, wherein at least one of the plurality of connected pipes includes an attachment means to connect to an existing hose, and wherein the plurality of connected pipes are configured to spray water into the hollow interior of the enclosure.

A second aspect of the invention provides a pet cleaning system, comprising: an enclosure for containing a pet, the enclosure including: a cover; and a base, wherein the cover removably connects to the base to form a cavity surrounded by a plurality of sides; and a plurality of connected pipes attached to the cover of the enclosure, wherein at least one of the plurality of connected pipes includes an attachment means to connect to an existing water supply, and wherein the plurality of connected pipes are configured to spray water into the cavity of the enclosure.

A third aspect of the invention provides a pet cleaning system, comprising: an enclosure for containing a pet, the enclosure including: a cover including a plurality of connected pipes located on an underside of the cover; and a base, wherein the cover connects to the base to form a cavity surrounded by a plurality of sides, wherein at least one of the plurality of connected pipes includes an attachment means to connect to an existing water supply, and wherein the plurality of connected pipes are configured to spray water into the cavity of the enclosure.

A pet cleaning system, comprising: a pet; an enclosure for containing the pet within a cavity, the enclosure including: a cover including a plurality of connected pipes located on an underside of the cover; and a base, wherein the cover connects to the base to form a cavity surrounded by a plurality of sides, wherein at least one of the plurality of connected pipes includes an attachment means to connect to an existing water supply, and wherein the plurality of connected pipes are configured to spray water into the cavity of the enclosure.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative pet cleaning enclosure according to an embodiment.

FIGS. 2A and 2B show perspective views of a side and an underside of a top of an illustrative pet cleaning enclosure according to an embodiment.

FIGS. 3A-3C show perspective views of various bases for an illustrative pet cleaning enclosure according to embodiments.

FIG. 4 shows an illustrative pet cleaning enclosure according to an embodiment.

FIG. 5 shows an illustrative pet cleaning enclosure according to an embodiment.

FIG. 6 shows an illustrative pet cleaning enclosure according to an embodiment.

FIGS. 7A-7F show various views of a pet cleaning enclosure according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a pet cleaning system. In an embodiment, the pet cleaning system includes a pet cleaning system, comprising: an enclosure for containing a pet, the enclosure including: a cover; and a base, wherein the cover connects to the base to form a cavity surrounded by a plurality of sides; and a plurality of connected pipes attached to the cover of the enclosure, wherein at least one of the plurality of connected pipes includes an attachment means to connect to an existing water supply, and wherein the plurality of connected pipes are configured to spray water into the cavity of the enclosure.

In another embodiment, the pet cleaning system includes an enclosure for containing the pet. The enclosure has a plurality of sides forming a hollow interior. At least one of the plurality of sides can comprise a solid piece of material. An opening, e.g., accessible by a door, can be located on one side of the enclosure to access the hollow interior. A plurality of connected pipes can be attached to the enclosure and at least one of the plurality of connected pipes can include an attachment means to connect to an existing water hose so that the plurality of connected pipes can spray water into the hollow interior of the enclosure. The enclosure also can include a drain for draining water from the enclosure.

It is understood that, unless otherwise specified, each value is approximate and each range of values included herein is inclusive of the end values defining the range. As used herein, unless otherwise noted, the term “approximately” is inclusive of values within +/− ten percent of the stated value, while the term “substantially” is inclusive of values within +/− five percent of the stated value. Unless otherwise stated, two values are “similar” when the smaller value is within +/− twenty-five percent of the larger value.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

A pet cleaning system according to embodiments of the invention can include an enclosure for containing a pet, such as a dog, but can be for any pet that would fit within the hollow interior of the enclosure. The enclosure can similar in size and shape to an existing dog cage but can also be any shape or size, and can be formed of any durable material that does not degrade when exposed to water. At least one of the sides of the enclosure can be at least partially formed of any type of a solid material, such as a plastic, and/or the like, that can prevent any water, soap, and/or the like, from exiting the hollow interior from that side. This can help prevent an owner from getting wet or dirty while cleaning their pet. In an embodiment, at least one side of the enclosure are at least partially formed of a solid material, e.g., to prevent water loss and/or improve effectiveness.

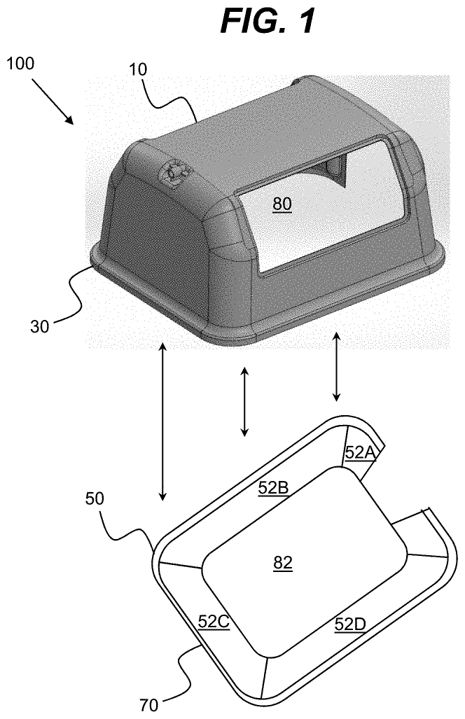

Turning to the drawings, FIG. 1 shows an illustrative pet cleaning system 100 according to an embodiment. The pet cleaning system 100 is an enclosure with a hollow cavity that is formed by a cover 10 connected to a base 50. The cover 10 removably connects to the base 50 using any solution (e.g., snap-fit, sliding and locking, and/or the like). That is, an edge 30 of the cover 10 can conform over an edge 70 of the base 50 to lock into place. The cover 10 includes a space 80 and the base 50 includes a space 82, and spaces 80, 82 form the hollow cavity of the enclosure for containing a pet.

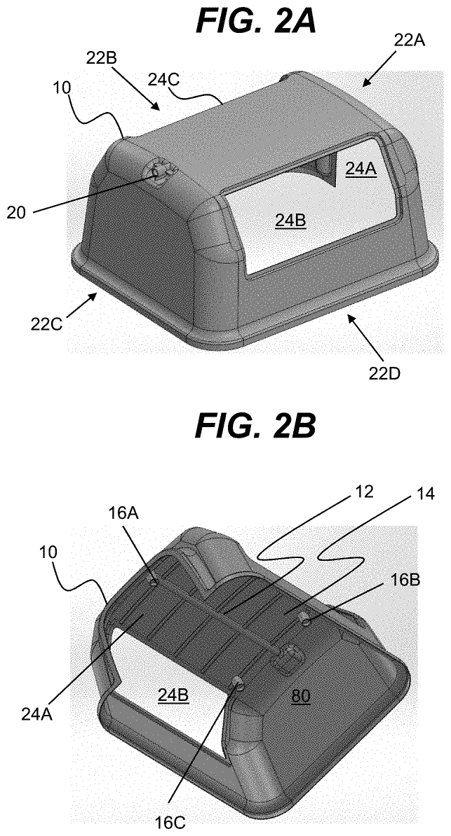

FIGS. 2A and 2B show perspective views of a side and an underside, respectively, of the cover 10 according to an embodiment. The cover 10 can be formed of any solid material that is impermeable to water and does not degrade when expose to water. In addition, the cover 10 can be formed a material that is substantially lightweight so that the pet cleaning system 100 is transportable. For example, the cover 10 can be made of a plastic or any suitable material. The cover 10, and the base 50 (FIG. 1), are shown as substantially rectangular in shape, but it is understood that the cover 10 and the base 50 can be any shape and size.

As seen in FIG. 2B, a plurality of connected pipes 12 are located on an underside 14 of the cover 10. Although a particular routing configuration of the plurality of connected pipes is shown in FIG. 2B, it is understood that this is for exemplary purposes only and that the plurality of connected pipes 12 can form any configuration. It is understood that this configuration of pipes is only illustrative of various possible routing configurations that can be utilized. For example, an embodiment can include no pipes located directly above the central region of the top of the enclosure to enable an opening to be located on the top side, e.g., to access the interior in order to rub soap on or off the pet, place the pet into or remove the pet from the interior, etc. Such an opening can be selectively accessed by a door.

The plurality of connected pipes 12 can be attached to the cover 10 using any solution (e.g., ties, welded, glue, clips, and/or the like). In an embodiment, one of all of the plurality of connected pipes 12 can be integrated into the underside 14 of the cover 10, e.g., formed in a solid material forming at least a portion of the underside 14. That is, the plurality of connected pipes 12 can be molded with the cover 10. The plurality of connected pipes 12 can be formed of any material that can be used for transporting water, such as metal, plastic, polyvinyl chloride (PVC) polymer, and/or the like. The plurality of connected pipes 12 includes a dispensing means 16A-16C for dispensing the water into the hollow cavity formed by the cover 10 and the base 50 (FIG. 1). The dispensing means 16A-16C can include any solution for distributing the water. For example, the dispensing means 16A-16C can be designed to control a direction and/or flow of the water. That is, the dispensing means 16A-16C can be a single opening, a nozzle with a varying cross-sectional area that distributes the water in a plurality of different streams, and/or the like. The dispensing means 16A-16C can be movable to control and adjust the direction of the flow of water. Although only three dispensing means 16A-16C are shown in FIG. 2B, it is understood that the plurality of connected pipes 12 can include any number of dispensing means 16A-16C for adequately distributing water within the enclosure.

At least one of the plurality of connected pipes 12 can include an attachment means 20 to connect to an existing hose for a water source. In an embodiment, the attachment means 20 includes a female fitting for connecting to an existing hose, such as a water hose connector. The female fitting can include a threaded connection, as known in the art. The attachment means 20 can also include a valve for controlling the flow of the water into the plurality of connected pipes 12. In another embodiment, a valve can be located at any location on the plurality of connected pipes 12 to control the flow of water being applied to the pet. In an embodiment, a level can be located at any location on the plurality of connected pipes 12 to control a direction (e.g., angle) of the water being applied to the pet.

The cover 10 can include a plurality of sides 22A-22D that match a plurality of sides 52A-52D of the base 50 (FIG. 1). In an embodiment, the cover 10 can also include a set of openings 24A-24C. In an embodiment, at least one of the shorter sides 22A, 22C includes an opening 24A that is sized for a head of the pet. In an embodiment, at least one of the longer sides 22B, 22D includes an opening 24B, 24C that allows an owner to access, wash, and view the pet within the enclosure.

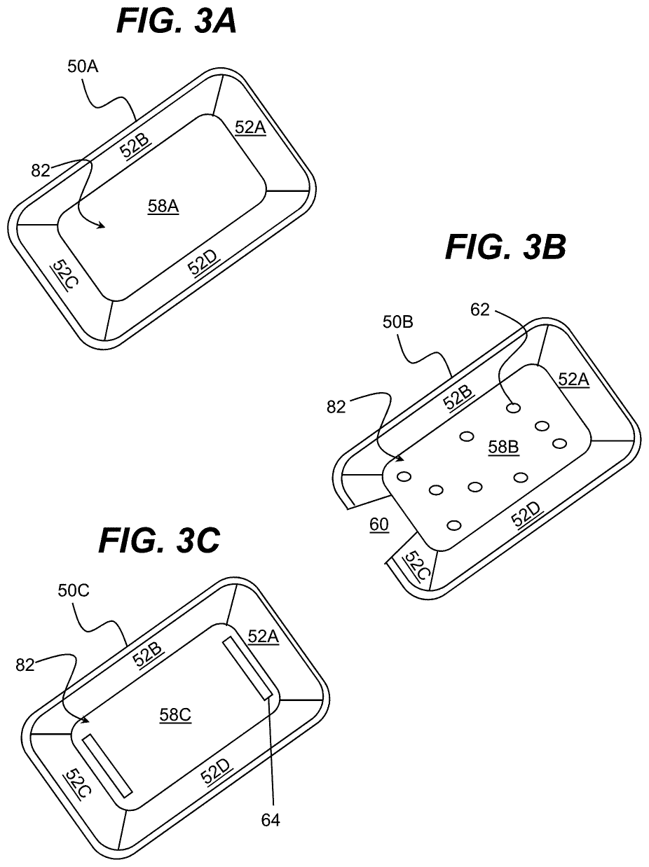

Turning now to FIGS. 3A-3C, perspective views of various bases 50A-50C for a pet cleaning system 100 (FIG. 1) according to embodiments are shown. The base 50A shown in FIG. 3A includes the plurality of sides 52A-52D and a bottom 58A that form the space 82. In an embodiment, the bottom 58A of the base 50A can be a solid piece of material that is permeable to water, but can withstand the weight of a pet. In another embodiment, the bottom 58A can be an opening that allows the pet to stand on the surface that the pet cleaning system 100 is placed on.

In another embodiment, the base 50B shown in FIG. 3B also includes the plurality of sides 52A-52D and the bottom 58B that form the space 82. However, the base 50B also includes a plurality of openings 62 located on the bottom 58B that can drain the water out of the pet cleaning system 100. The plurality of openings 62 can be located in a periodic or random configuration on the bottom 58B. The plurality of openings 62 can be sized to allow water to drain out but also not adversely affect the pet's ability to stand within the pet cleaning system 100. One of the sides 52C can also include an opening 60 that corresponds to the opening 24A in the cover 10 (FIGS. 2A, 2B) that allows a pet more space and/or water to drain out of the pet cleaning system 100.

In the base 50C shown in FIG. 3C, the bottom 58C includes a set of openings 64 located along at least one side 52A-52D. The set of openings 64 can substantially extend along the side of the base 50C. Although only two of the sides 52A, 52C include openings 64, it is understood that the bottom 58C can include openings along any of the sides 52A-52D.

It is understood that the base 50 (FIG. 1) can include any combination of the features shown in FIGS. 3A-3C to drain water out of the enclosure. It is understood that the bottom side of the enclosure can include a surface that is at least 90% solid and only 10% of the bottom side includes the plurality of openings. In this embodiment, the bottom side of the enclosure can be graded towards the plurality of openings.

In any of the embodiments, the base 50 can include a nonslip portion that prevents the pet from slipping while being washed.

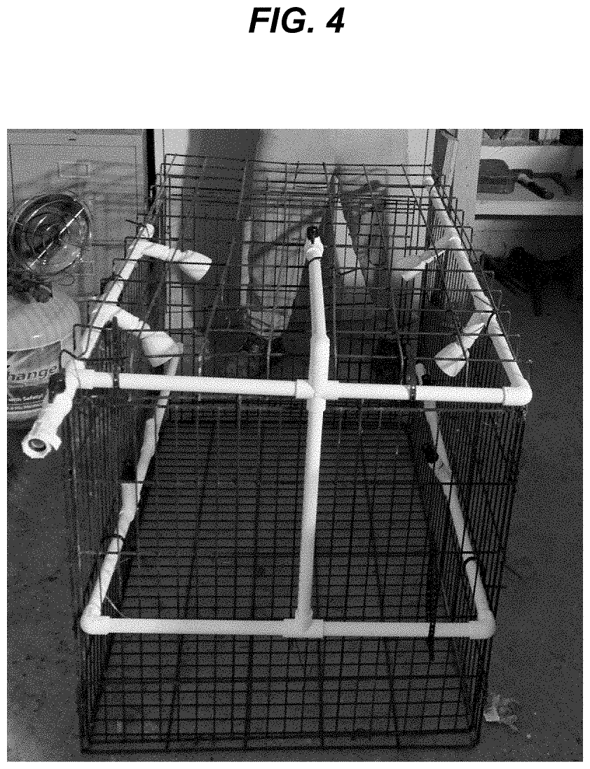

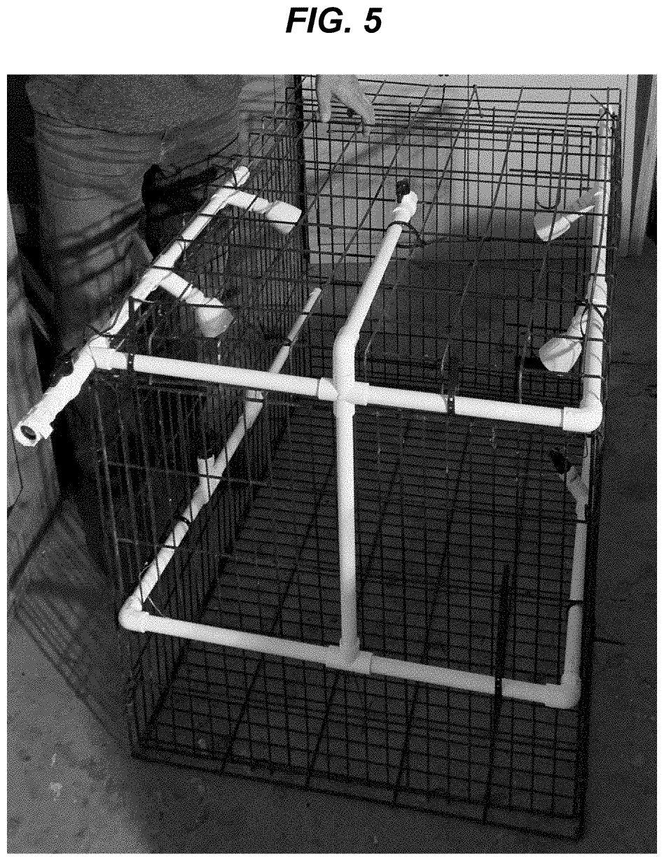

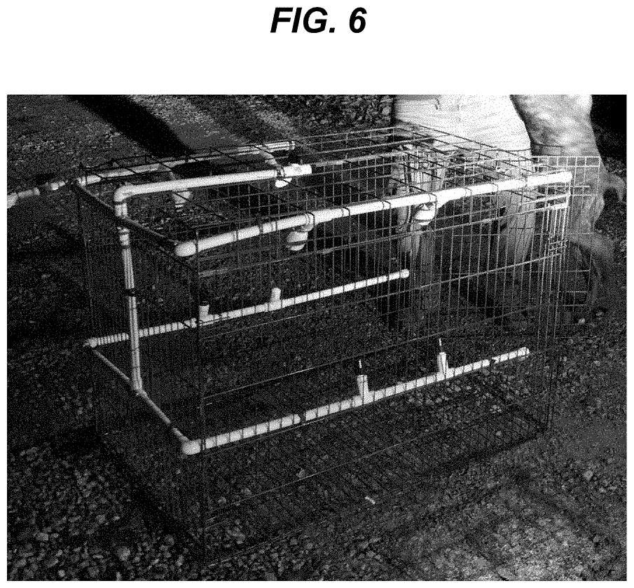

In an embodiment, the plurality of connected pipes can be incorporated into an existing pet cage, as shown in the pet cleaning system 200 in FIGS. 4-6. The plurality of connected pipes can include a first pipe that is located laterally along the top side of the enclosure and a second pipe that is located laterally along the bottom side of the enclosure. The second pipe can include a plurality of openings for spraying water and/or soap on the underside of a pet. In an embodiment, the first pipe can include a plurality of pipe extensions that extend from the first pipe towards the interior of the enclosure and allow for water and/or soap to spray into the interior from multiple sides of the pet. The first pipe can include a plurality of openings for spraying water and/or soap on the top side of the pet. In an embodiment, the plurality of connected pipes can include a third pipe and a fourth pipe that are located laterally along the longer sides that connect the top and bottom sides of the enclosure. In this embodiment, the third and fourth pipe can include a plurality of pipe extensions that extend towards the interior of the enclosure.

In order for a pet to enter the hollow interior of the enclosure in FIGS. 4-6, the enclosure can include an opening. The opening can be selectively accessed using an access door located on any one of the plurality of sides. In an embodiment, the access door includes a locking mechanism to prevent the pet from escaping the enclosure. The access door can include any mechanism that allows for an opening in the side to allow a pet to enter the enclosure. For example, the access door can include a portion of the side that swings open, slides to the side, and/or the like.

In an embodiment, a soap dispenser can be attached to the enclosure and be configured to dispense soap for cleaning a pet. The soap dispenser can be located on an exterior of the enclosure so that it can be easily accessed by the owner for refilling. In an embodiment, the owner can access soap from the soap dispenser and apply it directly on the pet on his own. In this case, a top of the enclosure can include openings (e.g., selectively accessed by doors), of a sufficient size to enable the owner to reach his/her arms into the enclosure to rub the soap on the pet. In an embodiment, the soap dispenser can be attached to a portion of the plurality of connected pipes, so that the soap or a soap/water mixture can be applied to the pet within the enclosure using the plurality of connected pipes.

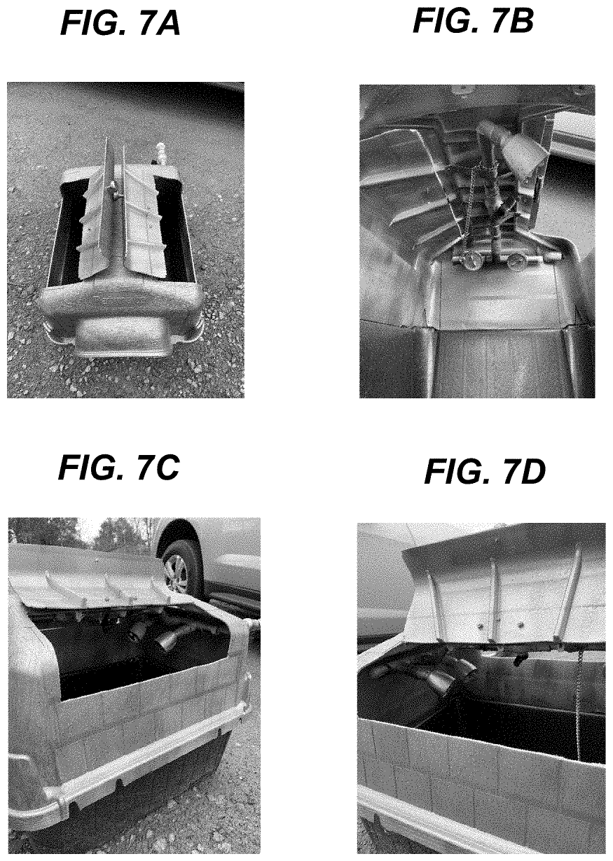

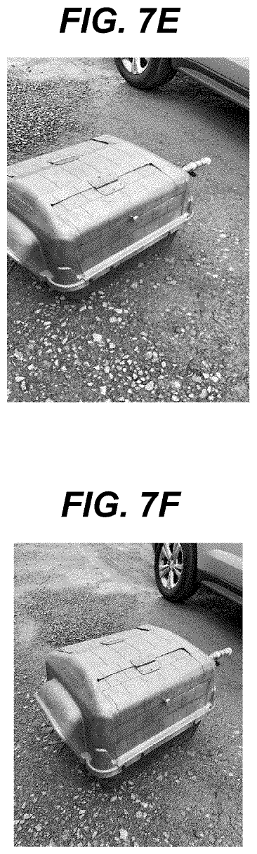

Turning now to FIGS. 7A-7F, various views of a pet cleaning enclosure according to an embodiment are shown. The pet cleaning enclosure includes openings on the sides of the cover that can be closed by a flap. On the underside of the cover, a plurality of connected pipes are located with at least one nozzle to spray the interior of the enclosure. The pet cleaning enclosure also has an opening for a pet to enter and/or stick their head out of the enclosure. The pet cleaning enclosure shown can include any of the features discussed in the previous embodiments.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A pet cleaning system, comprising:
an enclosure for containing a pet, the enclosure including:
a cover; and
a base, wherein the cover removably connects to the base to form a cavity surrounded by a plurality of sides; and
a plurality of connected pipes attached to the cover of the enclosure, wherein at least one of the plurality of connected pipes includes an attachment means to connect to an existing water supply, and wherein the plurality of connected pipes are configured to spray water into the cavity of the enclosure.

2. The pet cleaning system of claim 1, wherein at least one of the plurality of sides is at least partially formed from a solid piece of material.

3. The pet cleaning system of claim 1, wherein the cover includes a set of openings and at least one opening is located on one of the plurality of sides of the cavity.

4. The pet cleaning system of claim 3, wherein the at least one opening is located at one end of the enclosure to allow the pet to enter the enclosure.

5. The pet cleaning system of claim 3, wherein the at least one opening is located on one side of the enclosure to allow a user to access the cavity.

6. The pet cleaning system of claim 1, further comprising a drain for allowing water to drain out of the enclosure.

7. The pet cleaning system of claim 1, further comprising at least one valve located on at least one of the plurality of connected pipes to enable selective flow of water from a corresponding set of the plurality of connected pipes.

8. The pet cleaning system of claim 1, wherein the plurality of connected pipes is located on an underside of the cover.

9. A pet cleaning system, comprising:
an enclosure for containing a pet, the enclosure including:
a cover including a plurality of connected pipes located on an underside of the cover; and
a base, wherein the cover connects to the base to form a cavity surrounded by a plurality of sides, wherein at least one of the plurality of connected pipes includes an attachment means to connect to an existing water supply, and wherein the plurality of connected pipes are configured to spray water into the cavity of the enclosure.

10. The pet cleaning system of claim 9, wherein at least one of the plurality of sides is at least partially formed from a solid piece of material.

11. The pet cleaning system of claim 9, wherein the cover includes a set of openings and at least one opening is located on one of the plurality of sides of the cavity.

12. The pet cleaning system of claim 11, further comprising an opening located at one end of the enclosure to allow the pet to enter the cavity.

13. The pet cleaning system of claim 11, wherein the at least one opening is located on a long side of the cavity to allow a user to access the cavity.

14. The pet cleaning system of claim 9, further comprising a drain for allowing water to drain out of the enclosure.

15. The pet cleaning system of claim 9, further comprising at least one valve located on at least one of the plurality of connected pipes to enable selective flow of water from a corresponding set of the plurality of connected pipes.

16. A pet cleaning system, comprising:
a pet;
an enclosure for containing the pet within a cavity, the enclosure including:
a cover including a plurality of connected pipes located on an underside of the cover; and
a base, wherein the cover connects to the base to form a cavity surrounded by a plurality of sides, wherein at least one of the plurality of connected pipes includes an attachment means to connect to an existing water supply, and wherein the plurality of connected pipes are configured to spray water into the cavity of the enclosure.

17. The pet cleaning system of claim 16, wherein the cover includes a set of openings and at least one opening is located on one of the plurality of sides of the cavity.

18. The pet cleaning system of claim 17, further comprising an opening located at one end of the enclosure to allow the pet to enter the cavity.

19. The pet cleaning system of claim 17, wherein the at least one opening is located on a long side of the cavity to allow a user to access the cavity.

20. The pet cleaning system of claim 17, further comprising a drain for allowing water to drain out of the enclosure.
